(19) United States
(12) Patent Application Publication
(10) Pub. No.: US 2009/0085553 A1
(43) Pub. Date: Apr. 2, 2009

(54) Reconfigurable battery pack

(76) Inventors: Pavan Kumar, Portland, OR (US); Horacio Visairo-Cruz, Jal (MX); Scott Noble, Beaverton, OR (US)

Correspondence Address: Caven & Aghevli LLC;c/o CPA Global, P.O. BOX 52050, MINNEAPOLIS, MN, 55402, US

(21) Appl. No.: 11/906,177

(22) Filed: Sep. 28, 2007

(51) Int. Cl. H02J 1/00; H02J 7/00

(52) U.S. Cl. 323/351; 320/117

(57) ABSTRACT

In some embodiments, a system comprises a voltage regulator having two or more inputs with each having its own input voltage level and at least one switch to select between the input voltage levels, a configurable battery pack comprising at least two cells and at least one switch capable of configuring the battery in either a series configuration or a parallel configuration, a detector to measure a load parameter on the system; and a controller to send a signal to the at least one switch to select between the input voltage levels based on the measured load parameter.

### BACKGROUND

The subject matter described herein relates generally to the field of electronic devices and more particularly to a reconfigurable battery pack which may be used in connection with a dual input reconfigurable voltage regulator.

Portable computing equipment relies on battery systems to provide back-up power when the Alternating Current (AC) mains are unavailable. The duration that portable computing equipment system can operate on the DC battery depends on many factors including size of the battery, amount of energy drawn from the unit while performing different functions and power conversion efficiency of the voltage regulators that the battery is feeding.

### BRIEF DESCRIPTION OF THE DRAWINGS

The detailed description is described with reference to the accompanying figures.

FIG. 1 is a schematic illustration of a reconfigurable battery pack (RBP) configuration, according to embodiments.

FIGS. 2A-2C are schematic illustrations of a reconfigurable battery pack configuration with a reconfigurable voltage regulator (RVR), according to embodiments.

FIG. 3 is a flowchart illustrating operations in a method to operate a configurable battery pack, according to embodiments.

FIG. 4 is a schematic illustration of a battery pack in a series configuration with protection mechanisms (FETs), according to embodiments.

FIG. 5 is a schematic illustration of a battery pack in a series configuration with FETs rearranged to accommodate reconfigurability, according to embodiments.

FIG. 6 is a schematic illustration of an electronic device with which a reconfigurable battery pack may be implemented, according to embodiments.

### DETAILED DESCRIPTION

Described herein are exemplary systems and methods for implementing a reconfigurable battery pack for a dual input reconfigurable voltage regulator.

In the following description, numerous specific details are set forth, such as examples of specific data signals, named components, connections, number of voltage-levels, etc., in order to provide a thorough understanding of the embodiments of the invention. It will be apparent, however, to one of ordinary skill in the art that the embodiments of the invention may be practiced without these specific details. However, the specific numeric reference should not be interpreted as a literal sequential order but rather interpreted that the first voltage-level is different than a second voltage-level. Thus, the specific details set forth are merely exemplary. The specific details may be varied from and still be contemplated to be within the spirit and scope of the present invention.

In some embodiments there is provided a reconfigurable battery pack which allows the improvement of light-load efficiency of voltage regulators by adapting the input voltage as a function of the load draw in on the battery pack. In some embodiments, the input voltage can be changed by reconfiguring the internal connection of battery cells from a series connection to a parallel one, and vice versa. By changing the internal connection of battery cells as a function of load demands, operation conditions of the voltage regulator may be changed to reduce power loss and extend battery life.

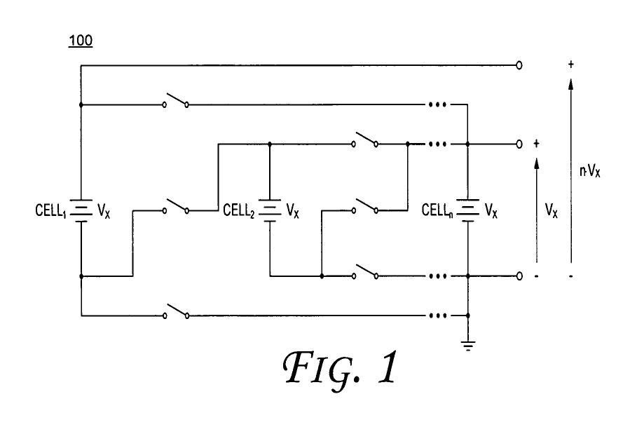

FIG. 1 is a schematic illustration of a battery pack configuration, according to embodiments. At heavy loads, where power losses are a combination of both conduction and switching losses, the battery pack can be configured as a conventional series connection, in which the voltage delivered to the input of the voltage regulator is equal to n*Vx where n corresponds to the number of cells connected in series and Vx corresponds to the voltage of each battery cell. At light loads, however, switching losses dominate and it is necessary to reduce both the switching frequency and the input voltage to keep a flat, high efficiency over the entire load range. Switching frequency can be reduced by using conventional methods such as skip mode, burst mode, hysteretic control, etc., but changing the input voltage can become a difficult task. To reduce the input voltage at light loads, the battery pack can be reconfigured to a parallel connection, delivering an input voltage to the voltage regulator equal to Vx.

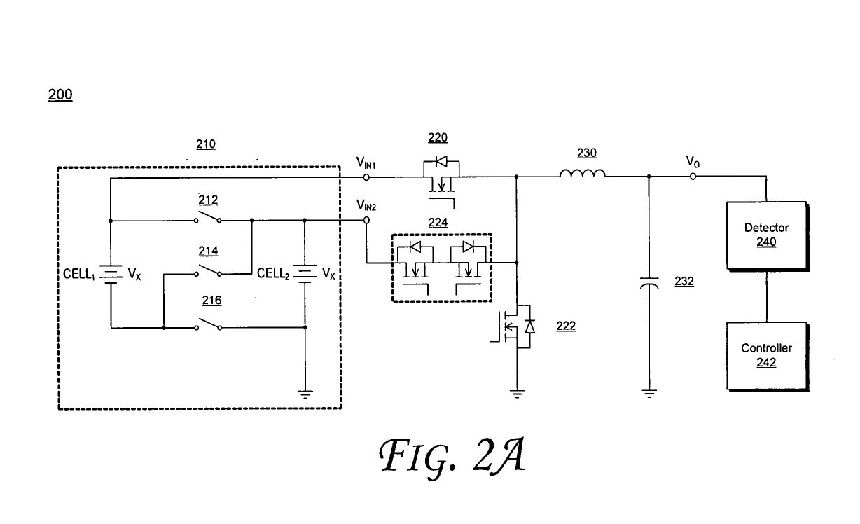

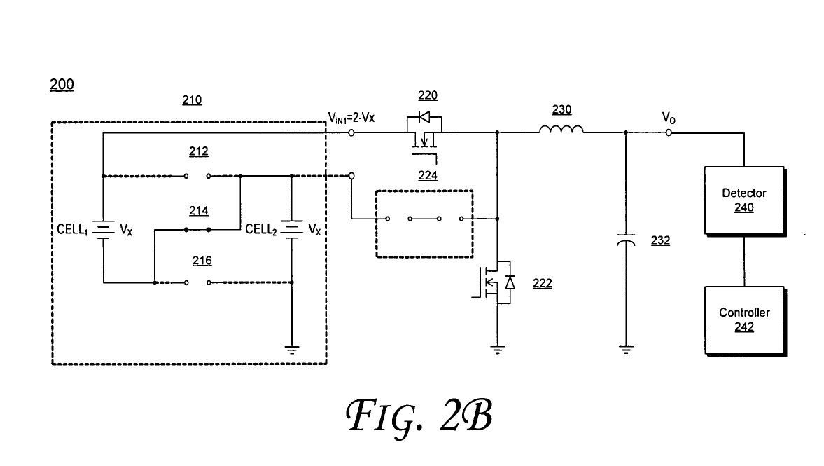

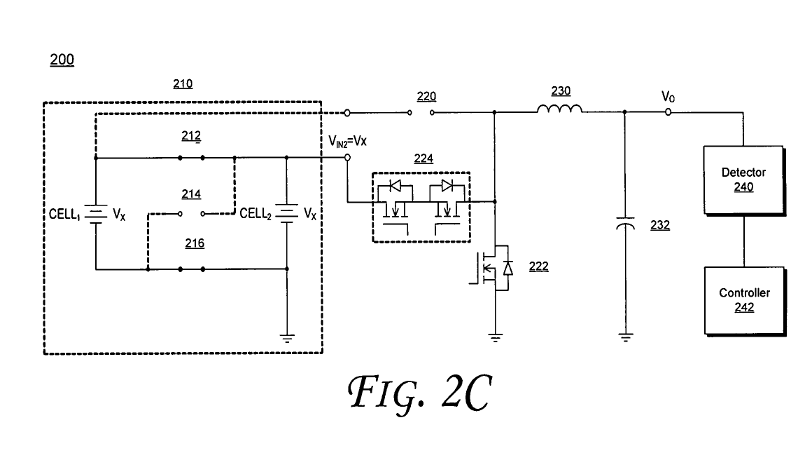

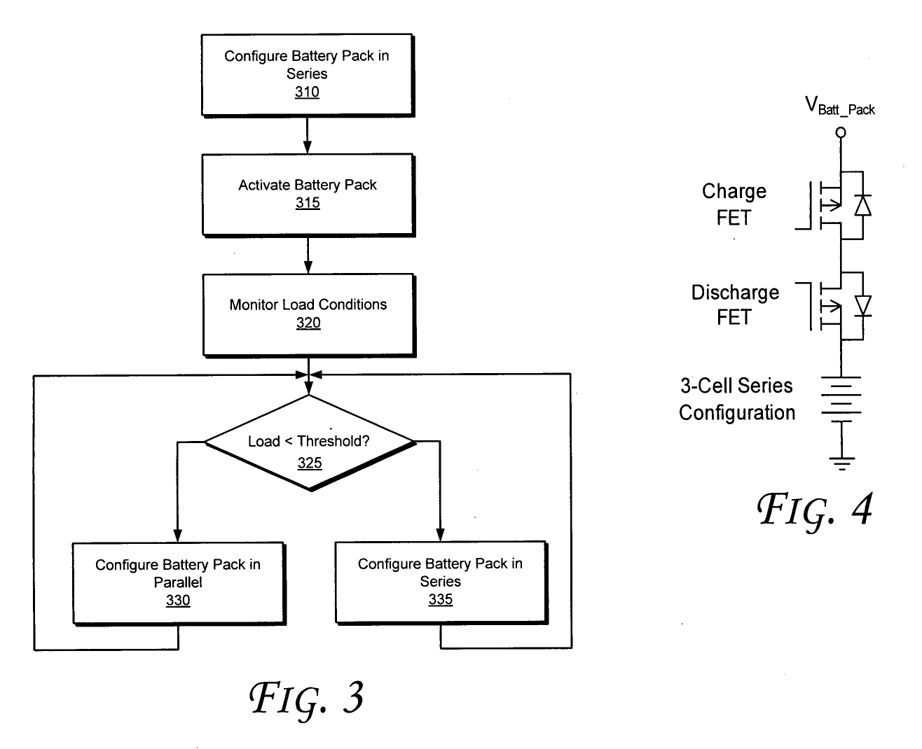

Operation of a reconfigurable battery pack will be described with reference to FIGS. 2A-2C and FIG. 3. FIGS. 2A-2C are schematic illustrations of a battery pack configuration shown with a dual Vin reconfigurable voltage regulator (RVR), according to embodiments. FIG. 3 is a flowchart illustrating operations in a method to operate a configurable battery pack, according to embodiments. In some embodiments, the operations depicted in FIG. 3 may be implemented in a controller such as, for example, controller 242.

In the embodiments depicted in FIGS. 2A-2C, a reconfigurable battery pack is used in conjunction with a dual Vᵢₙ reconfigurable voltage regulator. In some embodiments, the configuration of both the battery pack and the voltage regulator may be changed as a function of the load to maintain high efficiency over a wide load range.

Referring first to FIG. 2A, the system 200 comprises a battery pack 210, which in turn comprises two cells, indicated in FIG. 2A by cell₁ and cell₂. Battery pack 210 further comprises switches 212, 214, 216 connected across cell₁ and cell₂. System 200 further comprises switches 220, 222, 224 and inductor 230 and capacitor 232. A detector 240 is coupled to the system to detect the load V₀, and a controller 242 is coupled to detector 242.

In some embodiments the voltage regulator switches between two inputs, VIN1 and VIN2, depending on the load condition. At light loads, input voltage VIN2 is used in conjunction with reduced switching frequencies such that losses can be reduced to a large extent. As the load increases, the operation mode is switched to use VIN1 and higher switching frequencies. The combination of variable VIN and variable Fs can provide high efficiency operation over a wide load range.

Note, variable frequency operation can be implemented in many ways. Linear variations of frequency with load, pulse skipping, and hysteretic control are some of the common techniques. In some embodiments the controller 242 offers the feature of skip mode operation at light loads, which allows the voltage regulator to skip switching cycles when they are not needed.

Referring now to FIG. 3, in normal operation the battery pack is configured to operate in series (operation 310). Thus, referring to FIG. 2B, under normal operating conditions switches 224, 212, and 216 are disabled such that the voltage regulator operates in a continuous conduction mode (CCM), in which VIN1=2*Vx due to the series connection of battery cells. At operation 315, the battery pack is activated.

At operation 320, load conditions on the battery pack are monitored. For example, in some embodiments the detector 240 monitors load conditions on the battery pack. The load conditions may be transmitted to the controller 242, which implements a control routine to switch the configurable battery pack between a serious configuration and apparel configuration in response to changes in the load on the battery pack.

If, at operation 325, the load is greater than a threshold amount, and control passes to operation 335 in the battery pack remains configured in a serious configuration. By contrast, if at operation 325 the load is less than a predetermined threshold then control passes to operation 330 and the battery pack is configured to a parallel configuration.

Referring to FIG. 2C, at light loads, switches 220 and 214 are disabled and the voltage regulator operates in a variable frequency mode with VIN2=Vx due to the parallel configuration, which also increases the capacity of low-side battery cell.

In some embodiments, a dead time among internal switches of the battery pack is implemented to avoid a short circuit current through battery cells when the configuration is changed. As a result, the input voltage is not present during the transition from one input voltage to another.

FIG. 4 is a schematic illustration of a conventional battery pack in a series configuration. Referring to FIG. 4, a battery pack has two power switches in series (usually P-Channel FETs), which are used to fully disconnect the battery pack either from the battery charger or from the VR when the battery pack is charged or discharged, respectively.

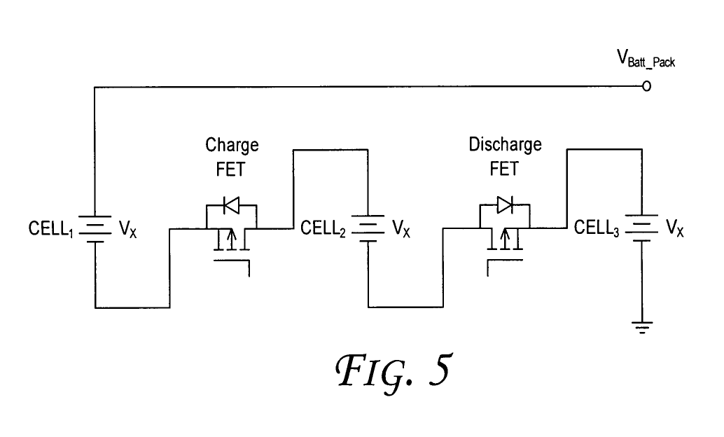

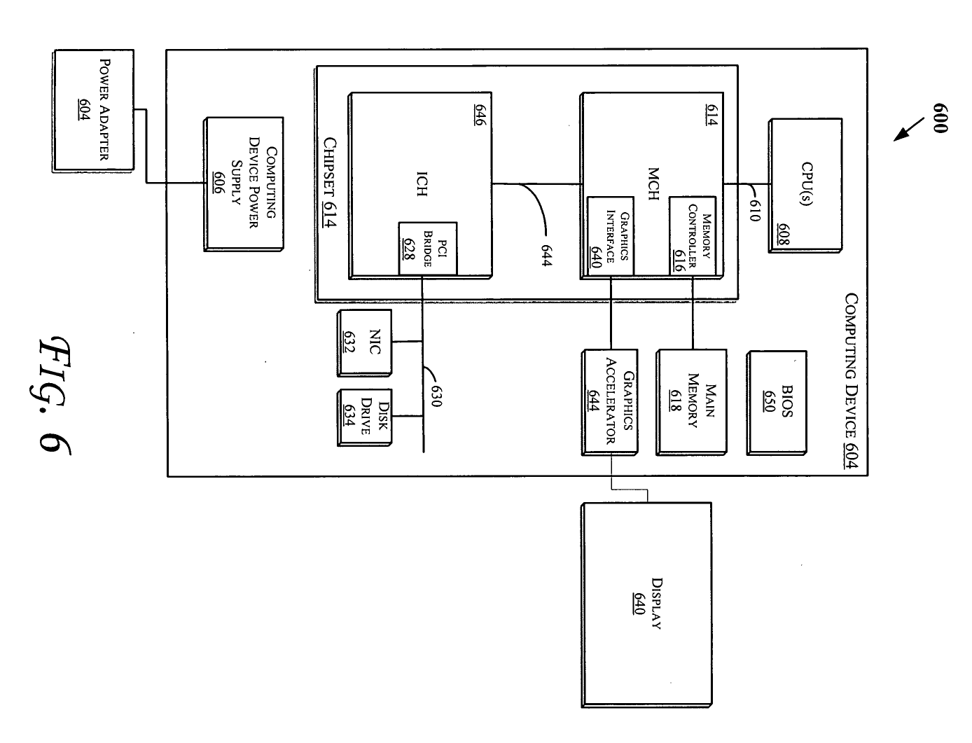

FIG. 5 is a schematic illustration of a battery pack in a series configuration, according to embodiments. Many conventional battery packs use internal switches to control the charge and discharge of battery cells. As a result, additional switches are not necessary for a series connection of up to 3 battery cells, as shown in FIG. 5. In consequence, efficiency at heavy loads is not affected due to the use of the Reconfigurable Battery Pack.

At light load conditions, however, 2*(n−1) switches are required to reconfigure an n-cell battery pack to a parallel connection. Since these additional switches are only used to connect the battery cells in parallel at light loads, conduction losses do not affect the overall efficiency of the voltage regulator. Since the input current drawn from each battery cell is the same and internal switches have the same RDS(ON), conduction losses can be approximated as shown in equation (1), which shows that the higher the number of battery cells in parallel, the lower the conduction losses.

$${P}_{CL\_Batt \_Pack} = {I}_{in}^{2} \cdot ( \frac{n - 1}{{n}^{2}} ) \cdot 2 \cdot {R}_{DS ( ON )} \qquad Equation 1$$

FIG. 6 is a schematic illustration of an architecture of a computer system which may include configurable battery as described herein. Computer system 600 includes a computing device 602 and a power adapter 604 (e.g., to supply electrical power to the computing device 602). The computing device 602 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 602 (e.g., through a computing device power supply 606) from one or more of the following sources: one or more battery packs, an alternating current (AC) outlet (e.g., through a transformer and/or adaptor such as a power adapter 604), automotive power supplies, airplane power supplies, and the like. In one embodiment, the power adapter 604 may transform the power supply source output (e.g., the AC outlet voltage of about 110 VAC to 240 VAC) to a direct current (DC) voltage ranging between about 7 VDC to 12.6 VDC. Accordingly, the power adapter 604 may be an AC/DC adapter.

The computing device 602 may also include one or more central processing unit(s) (CPUs) 608 coupled to a bus 610. In one embodiment, the CPU 608 may be one or more processors in the Pentium® family of processors including the Pentium® II processor family, Pentium® III processors, Pentium® IV processors, Core and Core2 processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 612 may be coupled to the bus 610. The chipset 612 may include a memory control hub (MCH) 614. The MCH 614 may include a memory controller 616 that is coupled to a main system memory 618. The main system memory 618 stores data and sequences of instructions that are executed by the CPU 608, or any other device included in the system 600. In some embodiments, the main system memory 618 includes random access memory (RAM); however, the main system memory 618 may be implemented using other memory types such as dynamic RAM (DRAM), synchronous DRAM (SDRAM), and the like. Additional devices may also be coupled to the bus 610, such as multiple CPUs and/or multiple system memories.

In some embodiments, main memory 618 may include a one or more flash memory devices. For example, main memory 618 may include either NAND or NOR flash memory devices, which may provide hundreds of megabytes, or even many gigabytes of storage capacity.

The MCH 614 may also include a graphics interface 620 coupled to a graphics accelerator 622. In one embodiment, the graphics interface 620 is coupled to the graphics accelerator 622 via an accelerated graphics port (AGP). In an embodiment, a display (such as a flat panel display) 640 may be coupled to the graphics interface 620 through, for example, a signal converter that translates a digital representation of an image stored in a storage device such as video memory or system memory into display signals that are interpreted and displayed by the display. The display 640 signals produced by the display device may pass through various control devices before being interpreted by and subsequently displayed on the display.

A hub interface 624 couples the MCH 614 to an input/output control hub (ICH) 626. The ICH 626 provides an interface to input/output (I/O) devices coupled to the computer system 600. The ICH 626 may be coupled to a peripheral component interconnect (PCI) bus. Hence, the ICH 626 includes a PCI bridge 628 that provides an interface to a PCI bus 630. The PCI bridge 628 provides a data path between the CPU 608 and peripheral devices. Additionally, other types of I/O interconnect topologies may be utilized such as the PCI Express™ architecture, available through Intel® Corporation of Santa Clara, Calif.

The PCI bus 630 may be coupled to a network interface card (NIC) 632 and one or more disk drive(s) 634. Other devices may be coupled to the PCI bus 630. In addition, the CPU 608 and the MCH 614 may be combined to form a single chip. Furthermore, the graphics accelerator 622 may be included within the MCH 614 in other embodiments.

Additionally, other peripherals coupled to the ICH 626 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

System 600 may further include a basic input/output system (BIOS) 650 to manage, among other things, the boot-up operations of computing system 600. BIOS 650 may be embodied as logic instructions encoded on a memory module such as, e.g., a flash memory module.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system, comprising:
a voltage regulator having two or more inputs with each having its own input voltage level and at least one switch to select between the input voltage levels;
a configurable battery pack comprising at least two cells and at least one switch capable of configuring the battery in either a series configuration or a parallel configuration
a detector to measure a load parameter on the system; and
a controller to send a signal to the at least one switch to select between the input voltage levels based on the measured load parameter.

2. The system of claim 1, wherein the at least one switch in the voltage regulator further comprises:
a first switch to receive a first input voltage level, a second switch to receive a ground potential voltage level, and a third switch to receive second input voltage level lower than the first input voltage level.

3. The system of claim 1, wherein the battery pack comprises:
a first switch to configure the battery pack in a series configuration; and
a second and third switches to configure the battery pack in a parallel configuration.

4. The system of claim 1, wherein the further comprising logic instructions stored on a computer readable medium which, when executed by the controller, configure the controller to:
compare the load measured by the detector to a threshold;
activate the first switch in the battery pack when the load exceeds a threshold.

5. The system of claim 1, wherein the further comprising logic instructions stored on a computer readable medium which, when executed by the controller, configure the controller to:
compare the load measured by the detector to a threshold;
activate the second and third switches in the battery pack when the load is beneath a threshold.

6. The system of claim 1, wherein the detector and the system controller send a signal to the one or more switches to select between the input voltage levels based on the measured load current.

7. A computer system, comprising:
a processor;
display device; and
a system to deliver power to the computer system, the system comprising:
a voltage regulator having two or more inputs with each having its own input voltage level and at least one switch to select between the input voltage levels;
a configurable battery pack comprising at least two cells and at least one switch capable of configuring the battery in either a series configuration or a parallel configuration
a detector to measure a load parameter on the system; and
a controller to send a signal to the at least one switch to select between the input voltage levels based on the measured load parameter.

8. The computer system of claim 7, wherein the at least one switch in the voltage regulator further comprises:
a first switch to receive a first input voltage level, a second switch to receive a ground potential voltage level, and a third switch to receive second input voltage level lower than the first input voltage level.

9. The computer system of claim 7, wherein the battery pack comprises:
a first switch to configure the battery pack in a series configuration; and
a second and third switches to configure the battery pack in a parallel configuration.

10. The computer system of claim 7, wherein the further comprising logic instructions stored on a computer readable medium which, when executed by the controller, configure the controller to:
compare the load measured by the detector to a threshold;
activate the first switch in the battery pack when the load exceeds a threshold.

11. The computer system of claim 7, wherein the further comprising logic instructions stored on a computer readable medium which, when executed by the controller, configure the controller to:
compare the load measured by the detector to a threshold;
activate the second and third switches in the battery pack when the load is beneath a threshold.

12. The computer system of claim 7, wherein the detector and the system controller send a signal to the one or more switches to select between the input voltage levels based on the measured load current.
